(19) United States
(12) Patent Application Publication
(10) Pub. No.: US 2020/0062169 A1
(43) Pub. Date: Feb. 27, 2020

(54) CONTROLLING A CONTROLLABLE HEADLIGHT OF A MOTOR VEHICLE

(71) Applicant: AUDI AG, Ingolstadt (DE)

(72) Inventors: Johannes REIM, Eichstätt (DE); Said OMERBEGOVIC, Frankfurt (DE)

(73) Assignee: AUDI AG, Ingolstadt (DE)

(21) Appl. No.: 16/481,701

(22) PCT Filed: Feb. 13, 2018
(86) PCT No.: PCT/EP2018/053500

§ 371 Date: Sep. 20, 2019

(30) Foreign Application Priority Data
Feb. 15, 2017 (DE) 10 2017 202 459.3

(51) Int. Cl. B60Q 1/12; B60Q 1/10

(52) U.S. Cl. CPC B60Q 1/12; B60Q 1/10; B60Q 2300/322; B60Q 2300/134; B60Q 2300/32; B60Q 2300/132

(57) ABSTRACT

The present application relates to a method for controlling a controllable headlight of a motor vehicle, in which the headlight is controlled in such a way that a predefinable light distribution is made available on a traffic route on which the motor vehicle is guided, wherein a profile of the traffic route is determined, and a light output of the headlight is set as a function of the determined profile of the traffic route in order to make available the predefinable light distribution, wherein the light distribution is made available by means of a multiplicity of pixels of a pixel headlight as a controllable headlight, for which purpose the lighting elements which form the pixels are controlled individually with respect to their light output, a region of the traffic route is determined in the direction of travel in front of the motor vehicle, which region is determined to be travelled on by the motor vehicle and is correspondingly bounded laterally, and the lighting elements are controlled in such a way that exclusively the region is illuminated with the predefinable light distribution.

### TECHNICAL FIELD

The present application relates to a method for controlling a controllable headlight of a motor vehicle, in which the headlight is controlled such that, on a traffic route on which the motor vehicle is driven, a predeterminable light distribution is provided, wherein a course of the traffic route is determined and a light output of the headlight is set depending on the determined course of the traffic route to provide the predeterminable light distribution. The present application also relates to a device for controlling a controllable headlight of a motor vehicle, wherein the device is designed to control the controllable headlight for providing a predeterminable light distribution on a traffic route on which the motor vehicle is driven by means of a signal, to determine a course of the traffic route and to set a light output of the headlight depending on the determined course of the traffic route in order to provide the predeterminable light distribution. Finally, the present application also relates to a motor vehicle.

### BACKGROUND

Methods for controlling controllable headlights in motor vehicles, devices as well as motor vehicles with such devices are well known in the art. For example, DE 197 13 884 A1 discloses a method for controlling the beam range and/or illumination direction in headlights of motor vehicles. Sensors collect information about the motor vehicle and its surroundings and, based on this information, a current headlight setting of the headlights should be able to be adapted proactively to the requirements for the illumination of the roadway.

Although this teaching has proved to be fundamentally correct, it nevertheless proves to be disadvantageous in that the headlights of the motor vehicle not only illuminate the road itself, but also project the lighting effect beyond the roadway, in particular laterally. This can lead to undesirable blinding effect, for example with respect to persons, cyclists and/or the like on a shoulder, oncoming vehicles and/or the like. The teaching of DE 197 13 884 A1 allows only a limited improvement in terms of illumination without a suitable adjustment.

In addition, DE 10 2013 219 097 A1 discloses a method for controlling an illumination of a traffic lane. By means of a headlight of a motor vehicle, light is emitted by a light element according to a light distribution, wherein the light distribution is to be varied as adapted light distribution on the basis of a vertical course of the traffic lane relative to the headlight as a function of distance. However, this only concerns the beam range and does not take into account any lateral limitations with respect to a light emission, which could possibly also result in blinding effect.

In this context, DE 197 16 784 B4 discloses a headlight system for vehicles. This teaching is directed so that vehicles travelling in front are not illuminated too much, so that blinding of a driver of the vehicle travelling in front can be avoided.

Furthermore, in this context DE 10 2008 061 747 A1 also discloses a method and a system for adapting a vehicle. By means of an assistance device, a driving instruction is to be generated which relates to a driving maneuver to be carried out by a vehicle operator. In accordance with the driving instruction, a light distribution generated by a lighting device of the motor vehicle or a detection range of an environmental sensor of the motor vehicle should be adaptable.

Finally, DE 590 399 C discloses a lane light projector for motor vehicles. With the lane light projector, laterally sharply defined light stripes can be projected, which should be readily visible despite illumination generated by headlights of the motor vehicle.

In current headlight systems, it is known to provide a dynamic cornering light, which shifts the light distribution during cornering towards the inside of the curve. The use of data from a camera system that is capable of recognizing a traffic lane can enable proactive control of the cornering light. Although the use of high-resolution headlight systems can enable more precise illumination of the roadway in order to assist the driver of the motor vehicle when cornering, but also on a straight section, the particular traffic lane on which the motor vehicle is driven by the driver is not additionally illuminated. This proves to be particularly disadvantageous when cornering, because in the dark unilluminated or only weakly illuminated areas of the traffic lane result, so that for the driver of the motor vehicle an increased risk of danger can arise.

Further, JP 2007-182151 A discloses a vehicle front headlight and a method for controlling it. EP 3 118 515 A1 discloses a vehicle headlight and a vehicle headlight control system. GB 2517790 A discloses a vehicle with a system for display. DE 10 2011 078 288 A1 discloses a motor vehicle with a warning device for the driver. Finally, DE 10 2009 009 472 A1 discloses a method for assisting a driver of a vehicle and a driver assistance system for a vehicle.

### BRIEF DESCRIPTION OF THE DRAWINGS/FIGURES

FIG. 1 shows a schematic representation of a motor vehicle, in accordance with some embodiments.

FIG. 2 shows a schematic representation of a motor vehicle, in accordance with some embodiments.

### DETAILED DESCRIPTION

The object of the present application is to improve the control of a controllable headlight and to provide a corresponding method and a corresponding device and a motor vehicle.

As a solution, the present application proposes a method, a device and a motor vehicle according to the independent claims.

Further advantageous embodiments will become apparent from the features of the dependent claims.

In some embodiments, a method is disclosed in which the light distribution is provided by means of a plurality of pixels of a pixel headlight as a controllable headlight, for which purpose the pixel-forming light elements are individually controlled with regard to their light output. The method also comprises determination of an area of the traffic route in the direction of travel in front of the motor vehicle, which is intended to be driven by the motor vehicle and is correspondingly laterally limited. The method comprises controlling the light elements such that the area is exclusively illuminated with the predeterminable light distribution.

In some embodiments, a headlight is disclosed. The headlight comprises a plurality of pixed for providing the light distribution. The pixels are formed by light elements that are individually controllable with respect to their light output, wherein the headlight is further configured to determine an area of the traffic route in the direction of travel in front of the motor vehicle, which is intended to be traveled by the motor vehicle and is correspondingly laterally limited, and to control the light elements for exclusively illuminating the area according to the predetermined light distribution.

In some embodiments, a motor vehicle is disclosed. The motor vehicle comprises a headlight as described herein.

As described herein, in a motor vehicle having a pixel headlight, improved illumination of the travel route, in particular a traffic lane of a roadway of the travel route, can be achieved. In contrast to what is possible, for example, according to the teaching of DE 197 13 884 A1, it can thus be achieved that the illumination of the traffic route is limited to the part which is intended to be driven by the motor vehicle. Thus, the light distribution may be controlled such that the light is not emitted substantially beyond the area for illumination.

In this way not only can an efficient use of light be achieved, because the emitted light is essentially only available for the illumination of the area and also other areas need not be illuminated, but moreover almost any adjustment of the illumination of the area of the travel route can be achieved, in particular if the area comprises varying contours, in particular laterally varying contours, such as may occur, for example, in the case of curves, but also in the case of variable traffic route widths and/or the like.

Unlike in the prior art, in this way it is possible, for example, that during cornering not only is an area illuminated, into which the motor vehicle drives during driving through the curve, but it is also preferably possible to illuminate an area that otherwise would not be illuminated due to driving through the curve, for example, on the outside of a curve or the like. Thus, it possible to achieve a significantly more precise illumination of the traffic route, in particular of the area.

In some embodiments, the headlight is a pixel headlight in which the plurality of pixels are arranged in the manner of a matrix. Each pixel is formed by a light element which can be controlled with respect to its light emission or light output by means of a signal which is usually electrical. The light elements can be individually controlled independently of each other, so that almost any light distribution can be provided by means of the pixel headlight. For this purpose, the pixel headlight may have light elements in the form of light-emitting diodes which are arranged appropriately and can be controlled with regard to their light output by means of a headlight-side control unit. In addition, the pixel headlight can also be formed by a laser scanner or the like, in which a conversion substance is irradiated by a laser beam, for example, in a line, point and/or the like, and the conversion substance emits light accordingly. The conversion substance thus provides the individual pixels of the pixel headlight. In such a headlight, it may also be provided that the pixels merge into each other almost without limit, for example, due to a corresponding control by the laser.

In some embodiments, the light output of the pixel headlight can be effected by means of its control. For this purpose, the control may itself have a control terminal, via which a corresponding light distribution can be predetermined by means of a signal which is to be emitted by means of the pixel headlight. A corresponding signal may be provided by means of the device of the present application. The device-of the present application is, therefore, intended to cooperate with such a pixel headlight, so that the desired light distribution according to the present application can be predetermined and can also be emitted by means of the pixel headlight as a light distribution.

The area of the traffic route is an area that is intended to be driven by the motor vehicle. Accordingly, lateral boundaries of the area result from a width of the area transverse to a direction of travel of the motor vehicle being greater than the width of the motor vehicle itself. The area can be, for example, a section of a roadway in the longitudinal direction or a traffic lane of the roadway in the longitudinal direction. The section can be formed, for example, by a distance in the direction of travel in front of the motor vehicle, which can be visually detected by a driver of the motor vehicle and/or can be detected by means of a suitable sensor, such as a camera system or the like. The area can also be laterally delimited by lateral markings as well as by a side edge of the traffic route. A marking for the lateral delimitation of the area may, for example, be a center strip of a road comprising at least two traffic lanes which are visually separated from one another by means of the center strip as a traffic lane marking. The area is preferably arranged in front of the motor vehicle in the direction of travel and can be determined accordingly by means of suitable sensors. It is preferably exclusively intended to be driven by motor vehicles in the direction of travel. In the direction of travel of the motor vehicle, the area may be limited by visibility for the driver and/or detectability by the sensor.

In some embodiments, the predeterminable light distribution is determined in such a way that the light elements of the pixel headlight are controlled such that exclusively illuminating the area with the predeterminable light distribution. There is essentially no lighting outside the area. The illuminated area basically does not need to include any straight side boundaries. Depending on the course of the traffic route or roadway or traffic lane, the area can also be curved laterally, for example, when the area extends into a curve or the like.

In some embodiments, a curvature of the traffic route and/or an initial curvature and/or a curvature change of the marking of the traffic route are taken into account. As a result, the course of the traffic route can be detected in a simple manner. For detecting the curvature or the marking, a camera system, a radar system, an infrared system and/or the like may be used.

In some embodiments, the course of the traffic route can be determined using a database, for example, by using a navigation system on-board the motor vehicle, a database external to the motor vehicle that can be contacted, for example, via a wireless communication link, and/or the like.

For the purpose of carrying out the method according to the embodiments described herein, the device may comprise a hardware circuit and/or a computer unit which can be controlled by means of a suitable computer program in order to be able to carry out the required evaluations and calculations.

In some embodiments, the motor vehicle is preferably an automobile, in particular a passenger car. The motor vehicle is also preferably driven by a driver. In addition, of course, an automated driving of the motor vehicle may be provided, in particular an autonomous driving of the motor vehicle.

In some embodiments, the light elements are controlled such that the predeterminable light distribution is limited to a predetermined distance in the direction of travel in front of the motor vehicle. As a result, the area can be limited in front of the motor vehicle. The predetermined distance may be, for example, a distance from the motor vehicle in the direction of travel. The distance may be, for example, about 50 m or less. Preferably, the predetermined distance is adjustable, for example, depending on a determined course of the traffic route, an adjustment by a driver or a control that autonomously drives the motor vehicle, and/or the like. The predetermined distance can thus also be varied during the travel of the motor vehicle in order to be able to make adjustments, for example, as required with regard to the illumination of the traffic route. If applicable, the predetermined distance may, of course, be greater than about 50 m, for example about 100 m, about 150 m or the like. It is also possible to predetermine an area for a given route, within which the predetermined route can be varied while the motor vehicle is traveling.

In some embodiments, the predeterminable light distribution is adapted in real time to a changed course of the traffic route. In this embodiment, the course of the traffic route is preferably determined continuously and for the method in accordance with some embodiments as described herein, changes are taken directly into account. As a result, the predeterminable light distribution can be adjusted accordingly, if required by the changed course of the traffic route, and may be done in real time, so that advantageously an immediate adaptation of the predeterminable light distribution is made possible, and can be further improved.

In some embodiments, a yaw angle and/or a pitch angle of the motor vehicle is taken into account for determining the predeterminable light distribution. As a result, effects that may occur due to the intended operation of the motor vehicle while driving, can also be taken into account in order to be able to adjust the light distribution accordingly. For example, it may be provided that effects due to yawing when driving through a curve can be compensated accordingly. In addition, it may also be provided that a pitch angle during deceleration of the motor vehicle is taken into account in front of a curve in order to continue to achieve a predeterminable illumination of the area of the traffic route, in particular independently of the pitch angle. Of course, this also applies to the yaw angle.

In some embodiments, the yaw angle and/or the pitch angle with respect to a marking of the traffic route is determined. In this way, the yaw angle and possibly also the pitch angle can be determined particularly reliably. The marking of the traffic route may be, for example, a center strip, a side strip, any other marking and/or the like.

In some embodiments, the course of the traffic route is determined based on data from a database. This may include, for example, the use of a database of a navigation system of the motor vehicle. In addition, of course, it may also be provided that a remote central database provides suitable data. Preferably, a wireless communication connection, for example via a mobile radio network and/or the like, is used for this database.

In some embodiments, the predeterminable light distribution may be determined based on a visibility range of a lane detection of a traffic lane of the traffic route on which the motor vehicle is driven. The visibility range may also be detected by means of a suitable optical sensor, preferably with a camera system or the like. As a result, the predeterminable light distribution can be suitably adapted to the respective visibility range, for example, when the visibility range is affected by precipitation or the like.

In some embodiments, in order to determine the course, a simulation of the traffic lane of the traffic route is determined in a projection plane in order to determine the area. The projection plane is a virtual plane that is available in a computer system and can be used to determine the course of the traffic route. By means of a suitable algorithm, a computer unit of the device can then determine the course using a simulation of the traffic lane of the traffic route in the projection plane. As a result, the area can be easily determined in order to be able to predetermine the light distribution for the area.

The advantages and effects stated for the method according to the embodiments as described herein apply equally to the device or the headlight according to the embodiments as described herein and to the motor vehicle equipped with the device or the headlight according to the embodiments as described herein and vice versa. In particular, device or headlight features can also be formulated for process features and vice versa.

The present application also includes further embodiments of the method, which include features such as were previously described in connection with the further embodiments of the motor vehicle as described herein. For this reason, the corresponding further embodiments of the method are not again described herein.

Exemplary embodiments are described below with reference to the drawings.

The exemplary embodiments explained below are preferred embodiments. In the exemplary embodiments, the described components of the embodiments each constitute individual features to be considered independently of one another, or in a combination different from that shown. In addition, features other than those already described may be added to the embodiments described.

In the drawings, elements with the same function have been provided with the same reference signs.

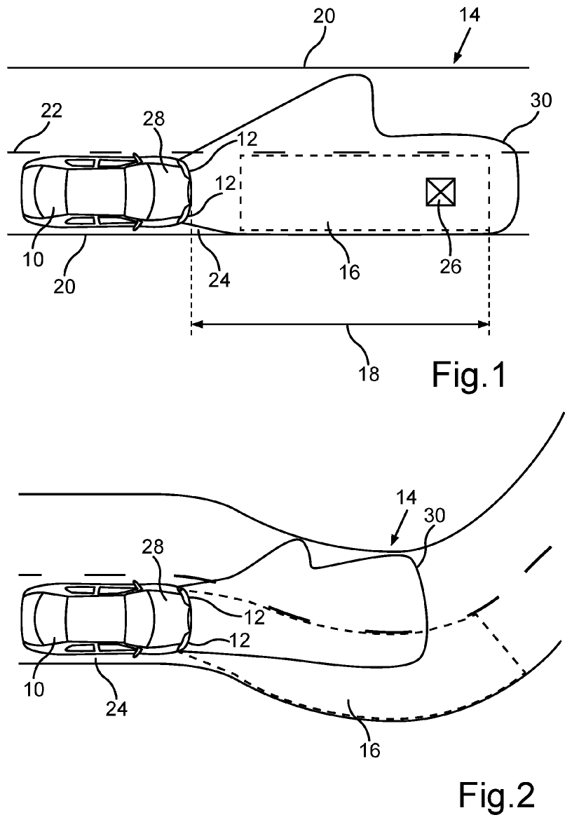

In accordance with some embodiments, FIG. 1 shows a schematic representation of a two-lane road 14 as a traffic route, which has a traffic lane 24 on which a motor vehicle 10 is driven by a driver of the motor vehicle 10. The road 14 is formed in this embodiment in the longitudinal direction in a straight line. The motor vehicle has two pixel headlights 12, which form controllable headlights of the motor vehicle 10. By means of a headlight control, not shown, the pixels of the respective pixel headlight 12 are controlled in order to provide a predeterminable light distribution. The pixel headlights in the present case are based on a light-emitting diode matrix. Alternatively, a laser scanner or the like may be provided at this point.

In the present case, the pixel spotlights 12 are controlled such that the predeterminable light distribution is provided on the road 14, in particular on the traffic lane 24 on which the motor vehicle 10 is driven. For this purpose, the device 28 is provided, which is connected to a camera system (not shown) of the motor vehicle 10, which can detect road markings, such as side lines 20 of the road 14 and a center line 22 of the road 14,. In addition, the device 28 is connected to the headlight control (not shown) of the pixel headlights 12. By means of a signal to the headlight control, the device 28 can control the pixel headlights 12 to provide the predetermined light distribution.

By means of the camera system, a course of the road 14 is determined. In the present case, the course is straight. Depending on the determined course of the road 14, a light output of the pixel headlights 12 is set to provide the predetermined light distribution.

The light distribution in the present case is provided by a plurality of pixels of the pixel headlight 12, for which purpose the pixel headlight 12 has pixel-forming light elements which can be individually controlled in terms of their light output, by the headlight control. The lighting elements in the present case are formed by individually controllable light-emitting diodes.

In the present embodiment, it is further provided that the device 28 at the same time also comprises the headlight control for the pixel headlights and the pixel headlights themselves. As a result, a compact unit is formed. In alternative embodiments at least partially separate assemblies may, of course, be provided here, which may also be arranged at different locations of the motor vehicle 10.

In the present case, an area 16 of the road 14, here in particular the traffic lane 24, which extends in the direction of travel in front of the motor vehicle 10 is determined by the device 28. The area 16 is intended to be driven by the motor vehicle 10 and accordingly is limited laterally. In the present case, the lateral boundaries consist of the center line 22 and a right side line 20.

The light elements of the pixel spotlights 12 are controlled such that exclusively the area 16 is illuminated with the predeterminable light distribution.

In the present case, it is further provided that the light elements are controlled such that the predeterminable light distribution is limited to a predetermined distance 18 in the direction of travel in front of the motor vehicle. The predetermined distance in the present case is about 50 m.

Furthermore, it is also provided in the present case that the area 16 does not begin immediately in front of the motor vehicle 10 but at a distance thereto. This takes into account the fact that the area in the direction of travel directly in front of the motor vehicle 10 as a rule cannot be viewed by the driver anyway and therefore lighting can be saved at this point. The invention makes it possible to limit the light distribution to the area 16 and thus to optimally utilize the light provided by the pixel spotlights 12 for the illumination of the area 16. As a result, an obstacle, such as the obstacle 26 shown in FIG. 1 in the area 16, can be detected very well by the driver of the motor vehicle 10.

From FIG. 1, it can be seen that, compared to lighting according to the prior art, which is shown by the reference numeral 30, a more precise illumination of the lane 24 can be achieved.

In accordance with some embodiments, FIG. 2 shows a further embodiment, which is based on the embodiment of FIG. 1, which is why reference is additionally made to the relevant embodiments.

In contrast to the embodiment according to FIG. 1, it is provided in the embodiment according to FIG. 2 that the road 14 has a curved course. The course of the lane 24 and the course of the side lines 20 and the center line 22 are formed accordingly as well.

With the device 28 and the connected camera system the course of the road 14, and here in particular the traffic lane 24, can now be detected. Accordingly, an area 16 is determined which is adapted to the course of the traffic lane 24 according to FIG. 2. The device 28 now generates a corresponding control signal for the headlight control, so that with the pixel headlights 12 a light distribution can be achieved, as shown in FIG. 2 for illuminating the area 16.

It can be seen with reference to FIG. 2 that—contrary to the prior art—the illumination of the traffic lane 24 in the direction of travel in front of the motor vehicle 10 can be substantially complete, so that the driver of the motor vehicle 10, can detect, fully illuminated, the traffic lane 24 on which he is to drive the motor vehicle 10.

In comparison, a roadway lighting of the prior art is shown by the reference numeral 30. The improved illumination of the traffic lane 24, as compared to the prior art, is clearly recognizable.

The information about the immediate roadway markings 20, 22 left and right of the motor vehicle 10 can be used by means of the device 28 to determine the limitation of the light distribution. In particular, the distance of the traffic lane in the transverse direction, a yaw angle difference between the motor vehicle 10 and one of the roadway markings 20, 22, an initial curvature of the roadway marking, a curvature change of the roadway marking, a visibility range of the lane recognition and/or the like can be utilized.

The limitation of the light distribution of the high-resolution headlight system by means of the pixel headlights 12 is determined by a simulation of the traffic lane 24 in a projection plane by means of a computer unit of the device 28. For this purpose, for example, the calculation of clothoids or splines using sensor data of the aforementioned sensors, in particular of the camera system, can be used. Based on the determined boundary of the area 16, the light distribution can be determined, which then allows the particular traffic lane 24 to be illuminated exactly.

The embodiments are merely illustrative and are not intended to limit the disclosure. In particular, of course, the design of the area to be illuminated can be varied as desired without departing from the spirit of the disclosure. In addition, the device can, of course, also be integrated into an existing vehicle control of the motor vehicle 10. For example, the device may also be realized by controlling a computer unit of the vehicle control system according to a computer program that implements the function as described herein.

1.-10. (canceled)

11. A method for controlling a controllable headlight of a motor vehicle, comprising:
determining a course of a traffic route of the motor vehicle;
determining an area of the traffic route in the direction of travel in front of the motor vehicle, wherein the area of the traffic route is a section of a traffic lane of a roadway in longitudinal direction intended to be driven by the motor vehicle, and wherein the section is detected at a distance in the direction of travel in front of the motor vehicle;
in response to the area being laterally delimited, taking into account at least one of a curvature of the traffic route, an initial curvature, and a curvature change of a marking of the traffic route; and
controlling each pixel-forming lighting element of a plurality of pixel-forming lighting elements to set output light of each pixel-forming lighting element based on the determined course of the traffic route to provide predeterminable light distribution exclusively in the area of the traffic route in the direction of travel in front of the motor vehicle,
wherein the section is visually detected by a driver of the motor vehicle or the section is detected by a sensor in the motor vehicle,
thereby providing the predeterminable light output during cornering on the traffic route in the direction of travel in front of the motor vehicle.

12. The method of claim 11, wherein the controlling each pixel-forming lighting element comprises:
controlling each pixel-forming lighting element of the plurality of pixel-forming lighting elements to limit distribution of the predeterminable light to a predetermined distance in the direction of travel in front of the motor vehicle.

13. The method of claim 11, wherein the controlling each pixel-forming lighting element comprises:
adapting the predeterminable light distribution in real time to a changed course of the traffic route.

14. The method of claim 11, further comprising:
determining the predeterminable light distribution based on at least one of a yaw angle or a pitch angle of the motor vehicle.

15. The method of claim 14, further comprising:
determining the yaw angle or the pitch angle according to marking of the traffic route.

16. The method of claim 11, wherein the predeterminable light distribution is determined based on a visibility range for a lane detection of the traffic lane of the roadway.

17. The method of claim 16, further comprising:
in order to determine the course and the area, performing a simulation of the traffic lane of the traffic route in a projection plane.

18. A device for controlling a controllable headlight of a motor vehicle, wherein the device is configured to:
determine a course of a traffic route of the motor vehicle;
determine an area of the traffic route in the direction of travel in front of the motor vehicle, wherein the area of the traffic route is a section of a traffic lane of a roadway in longitudinal direction intended to be driven by the motor vehicle, and wherein the section is detected at a distance in the direction of travel in front of the motor vehicle;
in response to the area being laterally delimited, take into account at least one of a curvature of the traffic route, an initial curvature, and a curvature change of a marking of the traffic route; and
control each pixel-forming lighting element of a plurality of pixel-forming lighting elements to set output light of each pixel-forming lighting element based on the determined course of the traffic route to provide predeterminable light distribution exclusively in the area of the traffic route in the direction of travel in front of the motor vehicle,
wherein the section is visually detected by a driver of the motor vehicle or the section is detected by a sensor in the motor vehicle,
thereby providing the predeterminable light output during cornering on the traffic route in the direction of travel in front of the motor vehicle.

19. The device of claim 18, wherein for the controlling each pixel-forming lighting element, the device is configured to:
control each pixel-forming lighting element of the plurality of pixel-forming lighting elements to limit distribution of the predeterminable light to a predetermined distance in the direction of travel in front of the motor vehicle.

20. The device of claim 18, wherein for the controlling each pixel-forming lighting element, the device is configured to:
adapt the predeterminable light distribution in real time to a changed course of the traffic route.

21. The device of claim 18, further configured to:
determine the predeterminable light distribution based on at least one of a yaw angle or a pitch angle of the motor vehicle.

22. The device of claim 18, further configured to:
determine the yaw angle or the pitch angle according to marking of the traffic route.

23. The device of claim 18, wherein the predeterminable light distribution is determined based on a visibility range for a lane detection of the traffic lane of the roadway.

24. The device of claim 23, further configured to:
perform a simulation of the traffic lane of the traffic route in a projection plane to determine the course and the area.

25. A motor vehicle comprising:
a device configured to:
determine a course of a traffic route of the motor vehicle;
determine an area of the traffic route in the direction of travel in front of the motor vehicle, wherein the area of the traffic route is a section of a traffic lane of a roadway in longitudinal direction intended to be driven by the motor vehicle, and wherein the section is detected at a distance in the direction of travel in front of the motor vehicle;
in response to the area being laterally delimited, take into account at least one of a curvature of the traffic route, an initial curvature, and a curvature change of a marking of the traffic route; and
control each pixel-forming lighting element of a plurality of pixel-forming lighting elements to set output light of each pixel-forming lighting element based on the determined course of the traffic route to provide predeterminable light distribution exclusively in the area of the traffic route in the direction of travel in front of the motor vehicle,
wherein the section is visually detected by a driver of the motor vehicle or the section is detected by a sensor in the motor vehicle,
thereby providing the predeterminable light output during cornering on the traffic route in the direction of travel in front of the motor vehicle.

26. The motor vehicle of claim 25, wherein for the controlling each pixel-forming lighting element, the device is configured to:
control each pixel-forming lighting element of the plurality of pixel-forming lighting elements to limit distribution of the predeterminable light to a predetermined distance in the direction of travel in front of the motor vehicle.

27. The motor vehicle of claim 25, wherein for the controlling each pixel-forming lighting element, the device is configured to:
adapt the predeterminable light distribution in real time to a changed course of the traffic route.

28. The motor vehicle of claim 25, wherein the device is further configured to:
determine the predeterminable light distribution based on at least one of a yaw angle or a pitch angle of the motor vehicle.

29. The motor vehicle of claim 25, wherein the device is further configured to:
determine the yaw angle or the pitch angle according to marking of the traffic route.

30. The motor vehicle of claim 25, wherein the predeterminable light distribution is determined based on a visibility range for a lane detection of the traffic lane of the roadway, the device is further configured to:
perform a simulation of the traffic lane of the traffic route in a projection plane to determine the course and the area.
